(19) United States
(12) Patent Application Publication
(10) Pub. No.: US 2012/0150573 A1
(43) Pub. Date: Jun. 14, 2012

(54) REAL-TIME SITE MONITORING DESIGN

(76) Inventor: Omar SOUBRA, (US)

(21) Appl. No.: 12/966,360

(22) Filed: Dec. 13, 2010

(51) Int. Cl. G06Q 10/00; G06F 17/50

(52) U.S. Cl. 705/7.11; 703/1; 705/29

(57) ABSTRACT

A method for designing a system for real-time site monitoring disclosed. A three-dimensional (3-D) model of a site is accessed by a computer system. The computer system determines a location for placing a monitoring sensor at the site. The computer system determines whether there is an obstruction at the site which inhibits receiving monitoring data by the monitoring sensor when at the location.

### BACKGROUND

During some projects such as tunnel construction and mining, a real-time monitoring survey, also known as a deformation survey, is performed as a safety measure. In the case of mining, such as open-pit mining, the surface of the mine is monitored to determine if there is shifting of the soil. This would indicate that a collapse of the soil, or underlying rock layers, is possible. An alert can be generated to evacuate the area until the cause of the shift of the soil surface is determined and appropriate safety measures can be implemented.

During tunnel construction, or other construction projects, a similar process is performed to determine whether there are shifts in the soil or underlying layers. More importantly, real-time monitoring can determine whether such a shift is undermining the foundations of a building which could lead to collapse of the entire building. Again, if such a shift is detected, the area can be evacuated before any injuries occur and steps can be taken to stabilize the building.

To implement a real-time monitoring system, sensors are placed at various locations at a construction site to detect movement of the ground surface, buildings, or other features which might indicate movement. In some instances, these sensors are placed inside of buildings as well to detect movement of the building. Currently, companies that implement real-time monitoring rely on experienced technicians who come to the site and determine the best locations for placing the sensors. At times, after the sensors are emplaced, they have to be moved in order to better monitor the site. For example, optical sensors are often used which measure the distance from a target such as a prism to the monitoring sensor (e.g., a laser range finding device). If the initial installation incorrectly placed the target or monitoring sensor, an obstruction in the sight line between these objects will prevent correctly monitoring the site. Thus, even with experienced technicians, the system has to be adjusted some times to implement real-time monitoring at the site.

### BRIEF DESCRIPTION OF THE DRAWINGS

The accompanying drawings, which are incorporated in and form a part of this specification, illustrate and serve to explain the principles of embodiments in conjunction with the description. Unless specifically noted, the drawings referred to in this description should be understood as not being drawn to scale.

FIG. 1 is a block diagram of an example computer system used in accordance with embodiments of the present technology.

FIGS. 2A and 2B are a flowchart of a method for implementing a real-time site monitoring design system in accordance with embodiments of the present technology.

FIG. 3 is a block diagram of an example real-time site monitoring design system in accordance with embodiments of the present technology.

FIGS. 4A, 4B, 4C, 4D, and 4E are plan views of a street illustrating features of a real-time site monitoring design process in accordance with embodiments of the present technology.

FIGS. 5A, 5B, and 5C are section views of a street illustrating features of a real-time site monitoring design process in accordance with embodiments of the present technology.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing terms such as “accessing,” “determining,” “generating,” “receiving,” “deriving,” “comparing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

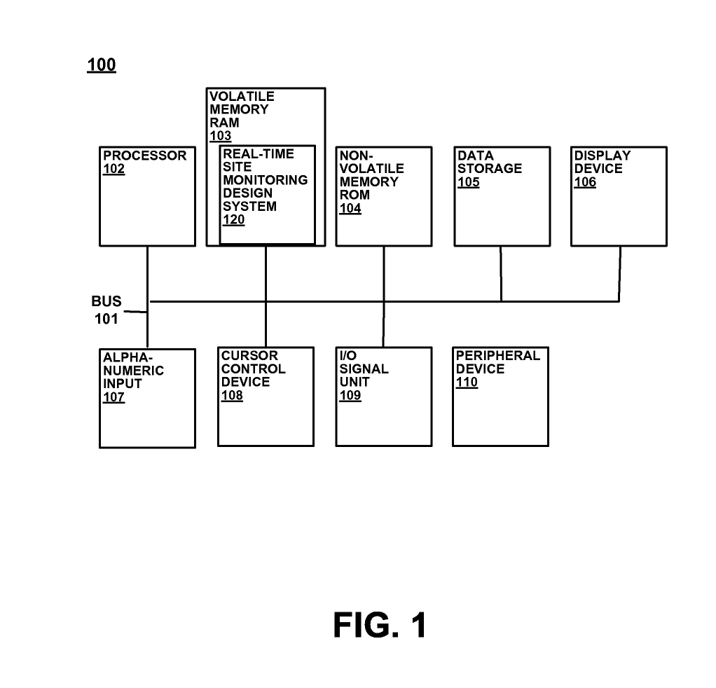

With reference to FIG. 1, embodiments are comprised of computer-readable and computer-executable instructions that reside, for example, in computer system 100 which is used as a part of a general purpose computer network (not shown). It is appreciated that computer system 100 of FIG. 1 is presented as an example only and that embodiments can operate within a number of different computer systems including general-purpose computer systems, embedded computer systems, laptop computer systems, hand-held computer systems, and stand-alone computer systems.

In the present embodiment, computer system 100 includes an address/data bus 101 for conveying digital information between the various components, a central processor unit (CPU) 102 for processing the digital information and instructions, a volatile main memory 103 comprised of volatile random access memory (RAM) for storing the digital information and instructions, and a non-volatile read only memory (ROM) 104 for storing information and instructions of a more permanent nature. In the embodiment of FIG. 1, real-time site monitoring design system 120 is implemented by executing computer-readable instructions residing in volatile main memory 103 which causes processor 102 and/or other components of computer system 100 to carry out the instructions. It should be noted that the computer-readable and executable instructions for real-time site monitoring design system 120 can be stored either in volatile memory 103, data storage device 105, or in an external storage device (not shown). In addition, computer system 100 may also include a data storage device 105 (e.g., a magnetic, optical, floppy, or tape drive or the like) for storing vast amounts of data. It is noted that data storage device 105 comprises or can receive a removable data storage device in one embodiment. Some non-limiting examples of a removable storage device include a Digital Versatile Disk (DVD) and a Compact Disk Read Only Memory (CD-ROM). It is appreciated that computer-readable and executable instructions for real-time site monitoring design system 120 can also be stored on such removable computer-readable storage media.

Devices which are optionally coupled to computer system 100 include a display device 106 for displaying information to a computer user, an alpha-numeric input device 107 (e.g., a keyboard), and a cursor control device 108 (e.g., mouse, trackball, light pen, etc.) for inputting data, selections, updates, etc. Computer system 100 can also include a mechanism for emitting an audible signal (not shown).

Returning still to FIG. 1, optional display device 106 of FIG. 1 may be a liquid crystal device, cathode ray tube, or other display device suitable for creating graphic images and alpha-numeric characters recognizable to a user. Optional cursor control device 108 allows the computer user to dynamically signal the two dimensional movement of a visible symbol (cursor) on a display screen of display device 106. Many implementations of cursor control device 108 are known in the art including a trackball, mouse, touch pad, joystick, or special keys on alpha-numeric input 107 capable of signaling movement of a given direction or manner displacement. Alternatively, it will be appreciated that a cursor can be directed and/or activated via input from alpha-numeric input 107 using special keys and key sequence commands. Alternatively, the cursor may be directed and/or activated via input from a number of specially adapted cursor directing devices.

Furthermore, computer system 100 can include an input/output (I/O) signal unit (e.g., interface) 109 for interfacing with a peripheral device 110 (e.g., a computer network, modem, mass storage device, etc.). Accordingly, computer system 100 may be coupled in a network, such as a client/server environment, whereby a number of clients (e.g., personal computers, workstations, portable computers, minicomputers, terminals, etc.) are used to run processes for performing desired tasks.

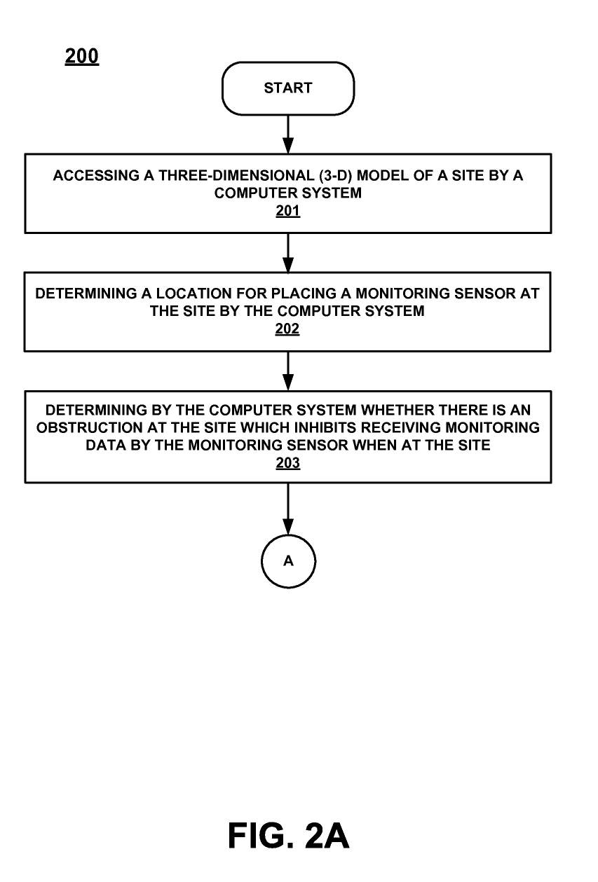

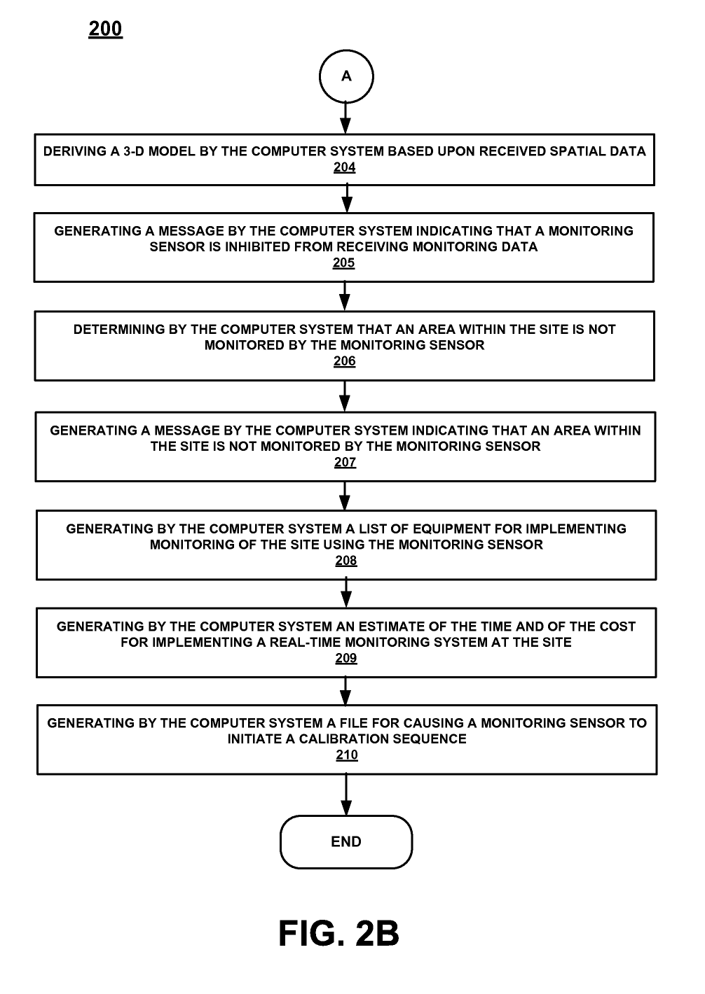

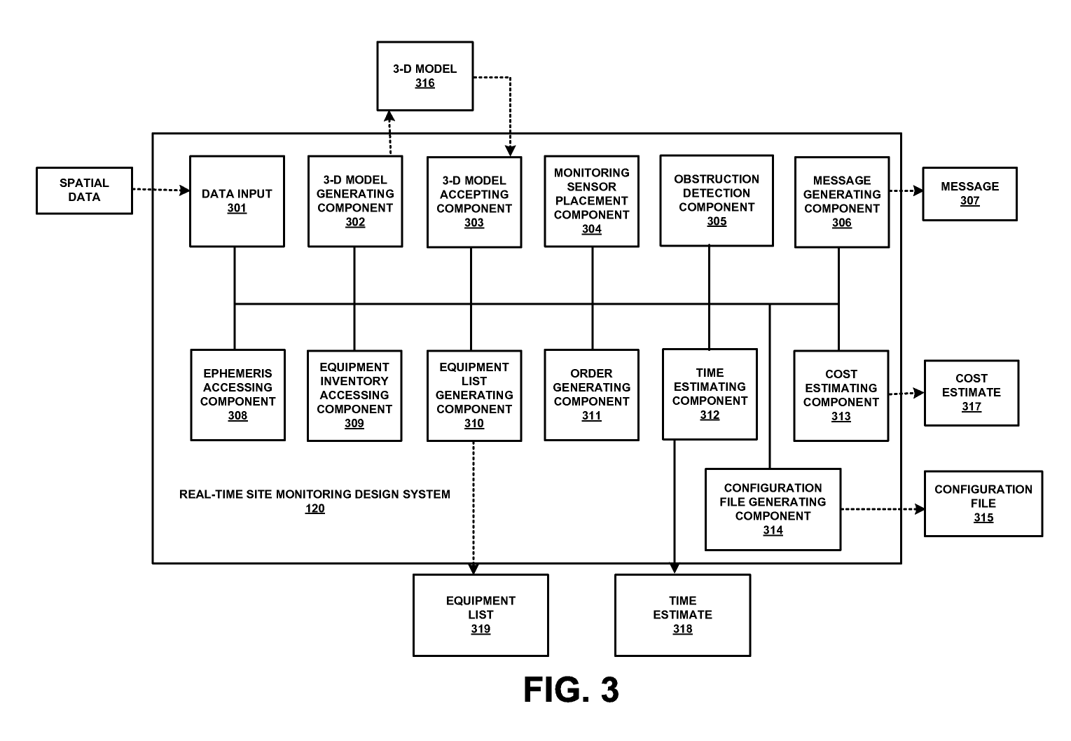

FIGS. 2A and 2B are a flowchart of a method 200 for implementing a real-time site monitoring design system in accordance with various embodiments. In operation 201 of FIG. 2A, a three-dimensional (3-D) model of a site (e.g., 3-D model 316 of FIG. 3) is accessed by a computer system. In one embodiment, when computer system 100 implements real-time site monitoring design system 120, it accesses a 3-D model of a site such as a construction site, a mining site, etc. It is noted that the 3-D model of the site can comprise the immediate area in which construction is being performed, as well as structures, features, and terrain which surround this area. The use of these structures, features, and terrain may be beneficial in more accurately monitoring whether deformation of the area is occurring.

There are a variety of sources of 3-D data which can be used in accordance with various embodiments. For example, many municipalities maintain 3-D models of portions of their cities to assist in city planning. In one embodiment, real-time site monitoring design system 120 can access this data for use in designing a real-time monitoring system. Alternatively, separate computer-aided design (CAD) files, site plans, or architectural plans can be used to generate a 3-D model. In another embodiment, survey data can be used to generate a 3-D model of a site for use by real-time site monitoring design system 120. In another example, a 3-D scanner uses a laser range finding device positioned at a known location to generate a set of coordinates and texture data. The 3-D scanner generates a “point cloud” which is used to render a 3-D model of the site during post processing of the data. Thus, the 3-D scanner can collect data which describes features of a site such as roads, buildings, trees, landforms, etc. which may be at a site. Other geo-spatial data can be used to generate a 3-D model of the site as well. For example, specialized software can be used to process multiple pictures of an object to derive a 3-D model of the object. The software generates a point cloud based upon analysis of the multiple pictures. In one embodiment, real-time site monitoring design system 120 can access a website which shows street views of city streets. By accessing two or more pictures of a given feature, real-time site monitoring design system 120 could generate 3-D models of objects at a site as well as their placement in site itself. It is noted that it may be preferable to use recently collected data to generate the 3-D model as this would provide the best the best current indication of the disposition of objects at a site and sight lines between different points at a site.

In one embodiment, the 3-D model used by real-time site monitoring design system 120 also shows obstructions to a view of the sky. As will be described in greater detail below, one type of sensor which can be used in real-time site monitoring relies upon received satellite navigation signals. As a result, it is useful to be able to plan whether obstructions to a clear view of the sky exist. In another example, it may be necessary to implement real-time site monitoring using monitoring sensors within buildings, tunnels, or other structures. Thus, in one embodiment, the 3-D model used by real-time site monitoring design system 120 may be a model of the interior of a building, tunnel, or other interior structure.

Returning to FIG. 2A, in operation 202 a location for placing a monitoring sensor at the site is determined by the computer system. Real-time site monitoring design system 120 determines one or more locations for placing monitoring sensors in or around a site based upon the 3-D model. In one embodiment, a user can specify parameters which are used by real-time site monitoring design system 120 in automatically determining where sensors should be placed at or around a site to give the desired level of deformation monitoring. In another embodiment, the user can place the monitoring sensors manually at different places within the site.

It is noted that a user can specify parameters which can be used by real-time site monitoring design system 120 in determining where to place monitoring sensors at a site. For example, the date and time of day may be factors in determining where to place monitoring sensors at a site. Furthermore, it may be desirable to detect movement in a variety of directions (e.g., multiple point measurements as opposed to single point measurements) which could necessitate the use of multiple sensors for monitoring that object. The user may want to monitor every major object (e.g., every building) at a site, a fraction of the buildings at a site, or a designated subset of the buildings at a site. For some objects, a user may want to monitor a plurality of points to more readily detect movement of the object, while for other objects, a single point measurement may be sufficient. Furthermore, the use can designate sub-areas of a site which would be monitored more/less than other sub-areas of the site. For example, if a tunnel is being built beneath a group of buildings, buildings could become susceptible to displacement if the tunneling undermines their foundations. This is more of a problem for larger buildings due to their greater weight. Thus, if a tunnel is being constructed in an area with mixed single and multi-story buildings, it may be more desirable to use multiple point measurements of the multi-story buildings and single point measurements of the smaller buildings.

It is noted that the type of monitoring sensor used can determine where the sensor is placed within the 3-D model in order to adequately implement real-time site monitoring. As described above, in one embodiment, real-time site monitoring design system 120 can use satellite navigation receivers to monitor movement of objects at a site. For example, Global Navigation Satellite System (GNSS) receivers can detect movement of objects, including their elevation, with a sub-centimeter level of precision. Alternatively, the 3-D scanners described above could be placed at locations at a site and monitor the movement of objects at the site. In another example, a robotic surveying station can measure the movement of an object using optical and/or laser monitoring of the object. One example of such a robotic surveying station is the S8 Total Station which is commercially available from Trimble Navigation Limited of Sunnyvale Calif. The S8 Total Station can either directly measure the distance and deflection to a particular target point of an object being monitored, or to a prism attached to the object. Additionally, the S8 Total Station can be programmed to monitor a plurality of target points based upon a defined polling interval.

In one embodiment, the placement of sensors is determined automatically by real-time site monitoring design system 120. In other words, using the 3-D model, real-time site monitoring design system 120 determines locations for emplacing monitoring sensors in order to implement real-time site monitoring. In one embodiment, real-time site monitoring design system 120 uses default settings to determine where to place sensors at a site in order to implement a real-time site monitoring system. In one embodiment, user-defined parameters are used by real-time site monitoring design system 120 to determine where to place sensors at a site in order to implement a real-time site monitoring system. In another embodiment, a user can manually place sensors within the 3-D model.

It is noted that many structures now incorporate dedicated monitoring systems to detect movement of the structure. In one embodiment, real-time site monitoring design system 120 can incorporate existing monitoring systems into the real-time site monitoring design it creates. For example, some bridges have sensors which run electric current through cables stretching the length of the bridge. As the cable stretches or contracts due to movement of the bridge, the sensors can detect a change in current passing through the cable. Similarly, some buildings have systems which monitor sway of the building. Embodiments of the present invention can incorporate these existing monitoring systems within the 3-D model as well to facilitate more comprehensive real-time site monitoring.

Returning to FIG. 2A, in operation 203, the computer system determines whether there is an obstruction at the site which inhibits receiving monitoring data by the monitoring sensor when at the location. In one embodiment, real-time site monitoring design system 120 is configured to determine whether obstructions prevent a monitoring sensor at the selected location from receiving monitoring data when emplaced, or which degrade the reception of monitoring data. For example, if the monitoring sensor comprises a laser range-finding device, real-time site monitoring design system 120 will determine whether there is an obstruction between the laser range-finding device and a feature being monitored. In other words, real-time site monitoring design system 120 can use the 3-D model to determine whether there are obstructions in the sight lines between the laser range finding device and target points, or prisms, at the site which would inhibit, degrade, or block the ability to detect movement of the feature being monitored.

Occasionally, even experienced installers/technicians of real-time site monitoring systems may incorrectly judge whether there is an obstruction, such as overhead wires, between a monitoring sensor and the feature being monitored. As a result, when the real-time site monitoring system is installed, sensors may have to be moved, or additional sensors installed to compensate for the obstruction. Using real-time site monitoring design system 120, a real-time site monitoring technician can more readily identify real or potential obstructions in sight lines at the site and make adjustments before actually installing the monitoring system.

In one embodiment, the identification of obstructions at the site is performed automatically by real-time site monitoring design system 120. For example, if the placement of monitoring sensors is performed automatically by real-time site monitoring design system 120, either in accordance with default settings or user-specified parameters, real-time site monitoring design system 120 will automatically determine whether obstructions exist which inhibit or prevent a monitoring sensor from receiving monitoring data. If the monitoring sensors are manually placed in the 3-D model by a user, real-time site monitoring design system 120 can perform an operation, either automatically or in response to a user selection, to determine whether obstructions exist which prevent a monitoring sensor from receiving monitoring data.

As described above, in some instances the monitoring sensor can comprise a GNSS receiver. If the monitoring sensor comprises a GNSS receiver, real-time site monitoring design system 120 will determine whether there is an obstruction which inhibits or prevents reception of signals from one or more GNSS satellites. For example, real-time site monitoring design system 120 can access satellite ephemeris data to determine which satellites are visible to GNSS receivers and at what time. This is possible because real-time site monitoring design system 120 uses the 3-D model to determine the field of view of GNSS receivers which are placed in the 3-D model based upon the time of day and position of the GNSS satellites. In so doing, real-time site monitoring design system 120 facilitates designing and installation of real-time site monitoring systems at a site. As a result, the necessity for experienced technicians to come out to a site and decide where to emplace sensors is reduced. Instead, real-time site monitoring design system 120 can be used by companies lacking this experience to design and install a real-time site monitoring system.

In operation 204 of FIG. 2B, a 3-D model of the site is derived by the computer system based upon received spatial data. In one embodiment, real-time site monitoring design system 120 causes computer system 100 to access data which is then used by real-time site monitoring design system 120 to derive the 3-D model described above. Again, real-time site monitoring design system 120 can access and integrate a variety of types of data in order to generate 3-D model 316. These include, but are not limited to, CAD files, site plans, architectural plans, existing 3-D models of the site, and survey data.

In operation 205 of FIG. 2B, real-time site monitoring design system 120 generates a message or alert which informs a user that a monitoring sensor is inhibited from receiving monitoring data based upon the proposed location within the 3-D model. As a result, a user can choose to manually move the sensor to a different location, or implant other changes to the real-time site monitoring system to compensate for the inability to receive monitoring data by the monitoring sensor. Alternatively, real-time site monitoring design system 120 can automatically move monitoring sensors around the 3-D model in order to compensate for the inability to receive monitoring data by the monitoring sensor. In one embodiment, real-time site monitoring design system 120 will also generate a message when the monitoring sensor has been moved to a location in the 3-D model in which it is not inhibited from receiving monitoring data by an object.

In operation 206 of FIG. 2B, the computer system determines that an area within the site is not monitored by the monitoring sensor. In one embodiment, real-time site monitoring design system 120 can determine whether there is a zone within the 3-D model, and thus the site itself, which is not being monitored by a monitoring sensor, or is not being monitored in accordance with user specified parameters. The determination that an area or zone within the site which is not monitored by a monitoring sensor can result from determining that monitoring of that area by one or more monitoring sensors is inhibited by an obstruction. Alternatively, real-time site monitoring design system 120 can determine that the area is not monitored in accordance with a user specified parameter (e.g., multiple point measurements rather than single point measurements). In another example, if a field computer system can only control 4 robotic total stations, and it is determined that six robotic total stations are needed to properly monitor the site, real-time site monitoring design system 120 can indicate that the area is not being monitored in accordance with specified parameters. It is noted that the above examples are not intended to represent a comprehensive listing of parameters for determining adequate monitoring of a site.

In operation 207 of FIG. 2B, a message is generated by the computer system indicating that an area within the site is not monitored by the monitoring sensor. Real-time site monitoring design system 120 can then generate a message indicating that a portion of the 3-D model, and thus the site itself, is not being adequately monitored in order to implement a real-time site monitoring system. In one embodiment, real-time site monitoring design system 120 can show the area which is not adequately monitored in the 3-D model itself. As a result, the user can manually place monitoring sensors within the 3-D model to provide adequate coverage, or real-time site monitoring design system 120 can add monitoring sensors within the 3-D model to provide adequate coverage.

In operation 208 of FIG. 2B, real-time site monitoring design system 120 can determine a list of equipment (e.g., equipment list 319 of FIG. 3) needed to implement the real-time monitoring system at the job site. This list can be generated based upon the monitoring sensors and other associated monitoring components that are placed by/with real-time site monitoring design system 120 within the 3-D model. This list can include, but is not limited to, monitoring sensors such as robotic total stations, 3-D laser scanners, GNSS receivers, cameras, power supplies, communications equipment, signal repeaters, field computers, prisms, etc. which are integrated at the site to implement real-time site monitoring. In one embodiment, real-time site monitoring design system 120 can access an inventory of equipment to determine whether there is sufficient equipment available to implement the real-time site monitoring system. This inventory of equipment can include, but is not limited to equipment in storage, equipment being repaired, equipment in use, rented equipment, etc. In one embodiment, real-time site monitoring design system 120 can determine whether the equipment available is sufficient for the job. If the equipment needed to implement real-time site monitoring is not available, real-time site monitoring design system 120 can order new equipment for purchase, or for rental, either automatically or in response to a user indication.

In operation 209 of FIG. 2B, an estimate of the time and of the cost for implementing a real-time monitoring system at the site is generated by the computer system. In one embodiment, real-time site monitoring design system 120 can also generate an estimate (e.g., time estimate 318 of FIG. 3) of the time needed to install/implement the real-time site monitoring system at the site. For example, a user can specify an initial estimate of the time needed to install each component at a site and the time needed to communicatively couple, and test, the components into an integrated real-time site monitoring system. Alternatively, real-time site monitoring design system 120 could provide a default estimate of the time needed to install/implement the real-time site monitoring system. The user can refine these estimates based upon real-world experience so that, over time, a more precise estimate of the time needed to install/implement the real-time site monitoring system. Using this information, real-time site monitoring design system 120 can automatically generate an estimate of the time needed to install/implement a real-time site monitoring system. Similarly, a user can specify an initial estimate (e.g., cost estimate 317 of FIG. 3) of the cost to install/implement a real-time site monitoring system at a site. Again, real-time site monitoring design system 120 can use default cost estimates, or user specified data in order to more precisely determine the cost of installing/implementing a real-time site monitoring system.

In operation 210 of FIG. 2B, a file for causing a monitoring sensor to initiate a calibration sequence is generated by the computer system. In one embodiment, real-time site monitoring design system 120 can generate a configuration file (e.g., configuration file 315 of FIG. 3) for monitoring sensors that are to be emplaced at the site. For example, when emplaced, a robotic total station has to be programmed with an azimuth and elevation to each target point which it will monitor at the site. In one embodiment, real-time site monitoring design system 120 can generate a configuration file for monitoring sensors emplaced at a site which will cause the monitoring sensor to initiate a calibration sequence. As a result, rather than having to manually program monitoring sensors at the site, the configuration file can be loaded into the monitoring sensor. The monitoring sensor can then initiate a calibration sequence which will facilitate verifying that target points at the site are correctly identified and measured by their respective monitoring sensors. For example, a configuration file for a robotic total station can comprise an azimuth and an elevation to each of the target points being monitored by the robotic total station. It is noted that, due to imprecision in the installation of the monitoring sensors and/or location of the target points, that the calibration sequence may not be precise enough to implement the real-time site monitoring system without additional tuning at the site. However, the configuration file can speed the process by pointing the robotic total station very close to the target point. In real-world installations, it can often be a problem finding or identifying the target points being monitored, especially as some robotic total stations may be installed at locations which make it difficult for a human operator to operate the equipment. However, the configuration file generated by real-time site monitoring design system 120 facilitates pointing the robotic total station at the correct azimuth and elevation such that a human operator can more rapidly find and identify the target points at a site.

FIG. 3 is a block diagram of an example real-time site monitoring design system 120 in accordance with embodiments of the present technology. In FIG. 3, spatial data is received by data input component 301. As described above, spatial data can comprise a previously completed 3-D model of a site, and/or raw data (e.g., 3-D scanner data, pictures, etc.) which can be used by real-time site monitoring design system 120 to generate a 3-D model of a site. In FIG. 3, a 3-D model generating component 302 is configured to render a 3-D model of a site using the spatial data received by data input 301. 3-D model accessing component 303 accesses the rendered 3-D model 316 of the site (or an existing 3-D model 316 if system 120 is not required to generate the 3-D model) to permit real-time site monitoring design system 120 to determine the placement of monitoring sensors within the 3-D model.

In FIG. 3, monitoring sensor placement component 304 is configured for determining the placement of a monitoring sensor within 3-D model 316. As described above, real-time site monitoring design system 120 can place monitoring sensors in 3-D model 316 in accordance with default settings, user specified parameters, or can be operated by a user to manually place the monitoring sensors within 3-D model 316. In one embodiment, monitoring sensor placement component 304 can use knowledge of operating parameters of various monitoring sensors in determining the placement of monitoring sensors in 3-D model 316. For example, monitoring sensor placement component 304 can utilize knowledge of minimum/maximum elevation, and horizontal range of motion for a robotic total station, as well as detection thresholds of the sensors used by the robotic total station, as parameters which determine where monitoring sensors are to be placed in 3-D model 316.

In FIG. 3, obstruction detection component 305 is configured to determine whether an obstruction exists at the site, as determined using 3-D model 316, which inhibits receiving monitoring data by a monitoring sensor when at the location a monitoring sensor from receiving monitoring data when installed at the site. Because real-time site monitoring design system 120 can create a detailed 3-D model of the site, and can leverage knowledge of sensor placement and detection capabilities of the monitoring sensors used, obstruction detection component 305 can determine whether there is an obstruction which inhibits, degrades, or prevents the reception of monitoring data by a monitoring sensor. For example, a tree could block a robotic total station from having a clear field of view of all target points that it is to be monitoring when installed at the site. Similarly, a tree, or other obstruction, could prevent a GNSS receiver from having a clear view of GNSS satellites as they pass overhead. Furthermore, obstruction detection component 305 can determine whether there is an area within a site which is not covered by a monitoring sensor, or which is not covered in accordance with specified parameters.

Message generating component 306 is configured for generating messages 307 in response to specified events. Examples of events which can trigger message generation include, but are not limited to, detection of an obstruction which inhibits receiving monitoring data by a monitoring sensor, detection of an area which is not covered by a monitoring sensor, generation of a cost estimate, generation of a time estimate, generation of an equipment order, etc.

In FIG. 3, ephemeris accessing component 308 is configured to access satellite ephemeris data to facilitate obstruction detection component 305 in determining whether an obstruction inhibits the reception of monitoring data. As described above, the positions of GNSS satellites are known, as well as what times each satellite is in view from a given location. Using this knowledge, obstruction detection component 305 can determine whether there is an obstruction at a site which will prevent a GNSS receiver from obtaining a clear view of a given GNSS satellite, and whether this will prevent determining with a sufficient degree of precision whether an object is moving. For example, obstruction detection component 305 can determine that a given GNSS receiver is blocked from viewing a satellite by a particular object. However, this may not be a problem if there enough GNSS satellites in view in other parts of the sky to facilitate a position fix to a desired/required level.

In FIG. 3, equipment inventory accessing component 309 is configured for determining what equipment is available for a given real-time site monitoring project. For example, equipment inventory accessing component 309 can compare lists of equipment purchased, equipment currently being used elsewhere, equipment lost or stolen, equipment being repaired, etc. to determine what equipment is available for a given real-time site monitoring project. In one embodiment, these lists are generated by equipment inventory accessing component 309. Equipment list generating component 310 is configured for generating a list of equipment (e.g., equipment list 319) needed to implement a real-time site monitoring system at a site. As described above, equipment list 319 can include, but is not limited to monitoring sensors such as robotic total stations, 3-D laser scanners, GNSS receivers, cameras, power supplies, communications equipment, signal repeaters, field computers, prisms, etc. which will be used to implement real-time site monitoring when installed per the placement of monitoring sensors that is produced by system 120.

In FIG. 3, order generating component 311 is configured to determine whether equipment purchases or rentals are necessary in order to implement a real-time site monitoring system. For example, order generating component 311 can determine differences between the data generated by equipment inventory accessing component 309 and equipment list generating component 310 to determine whether there is a shortage of equipment needed to implement a real-time site monitoring system. In one embodiment, order generating component is configured to automatically generate an order to needed equipment based upon user specified parameters.

In FIG. 3, time estimating component 312 and cost estimating component 313 are configured to generate time estimate 318 and cost estimate 317 respectively. As described above, real-time site monitoring design system 120 can be used to generate bids for projects based upon the time needed to complete a project and the cost to implement/install the system. As described above, a user can manually enter parameters which permit real-time site monitoring design system 120 to generate time estimate 318 and cost estimate 317. These parameters can be further refined based upon experience to generate more precise estimates of the time and cost for implementing/installing a real-time site monitoring system at a site.

In FIG. 3, configuration file generating component 314 is used to generate configuration file 315. As described above, configuration file 315 is used to load data into monitoring sensors so that when initially installed at the site, the monitoring sensor will initiate a calibration sequence. As a result, manual programming of monitoring sensors at the site can be reduced which facilitates installing the system. Also, 3-D model 316 facilitates configuring the monitoring sensors such that they can more rapidly detect and measure target points at the site when installed. In the past this has been performed manually and can be difficult depending upon the location of the monitoring sensor and the size and distance to a target point. For example, manually programming a robotic total station can be difficult when it is located high up on a building and when trying to locate a prism located some distance away, especially when window reflections etc. can confuse an operator as to what the target point is. In contrast, configuration file 315 facilitates pre-loading data into the robotic total station so that the azimuth and elevation for finding the target prism is already programmed into the robotic station. As a result, the robotic total station can be installed and the calibration sequence initiated. Using the data from configuration file 315, the robotic total station can be pointed in the vicinity of the target prism which will facilitate finding and identifying it during set-up of the real-time site monitoring system.

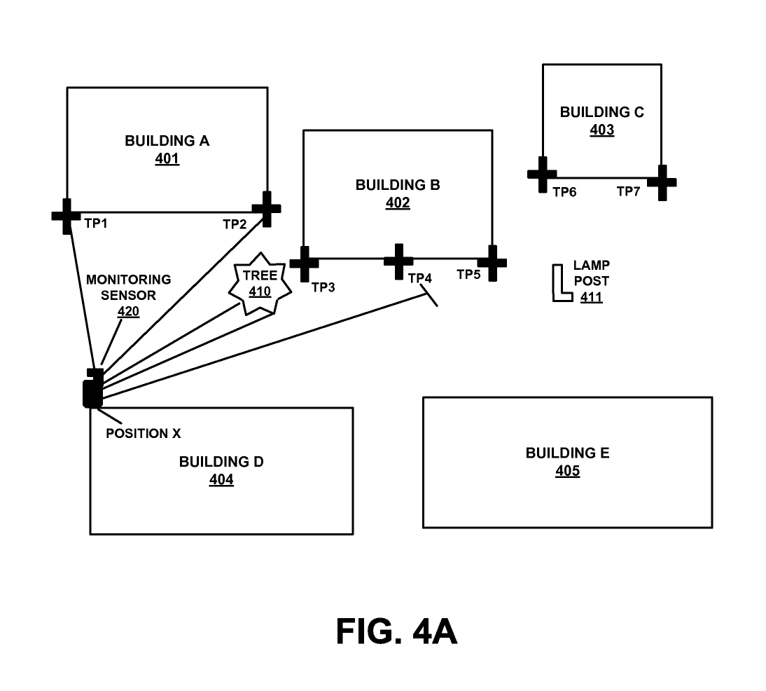

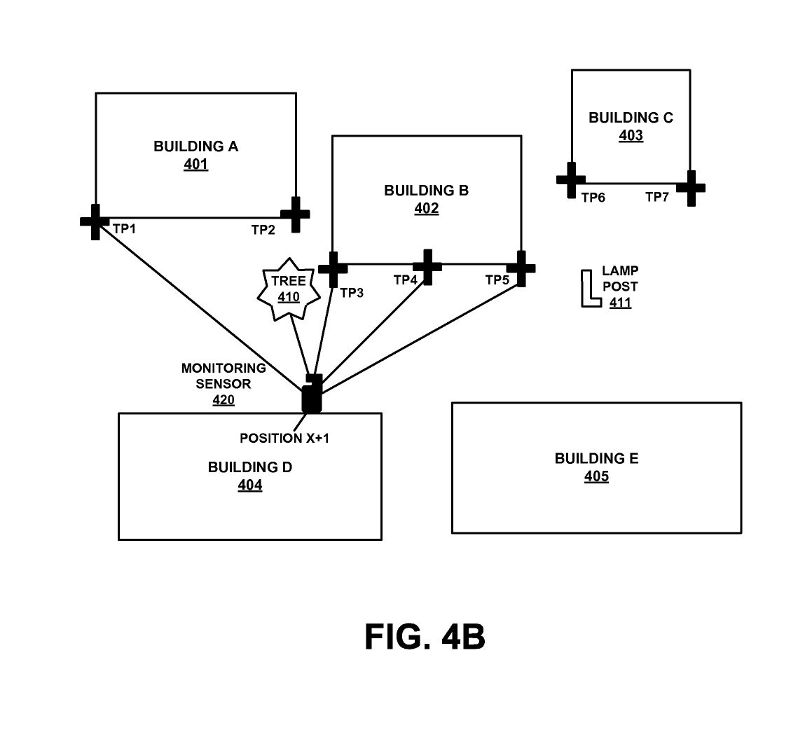

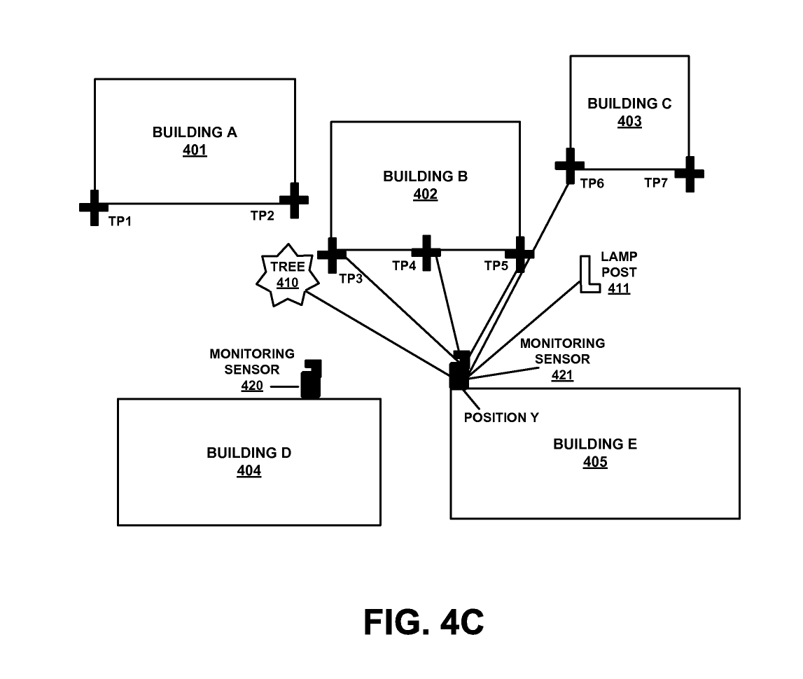

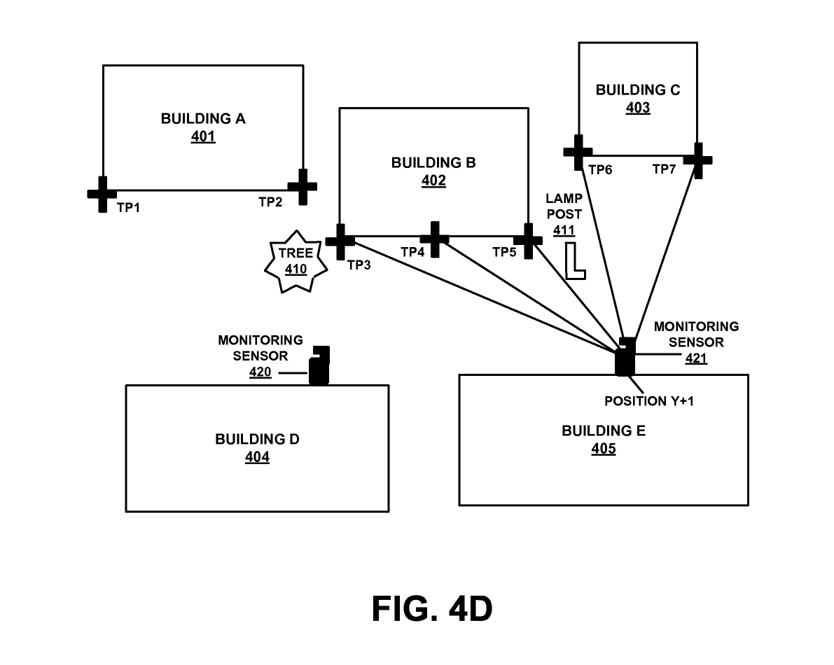

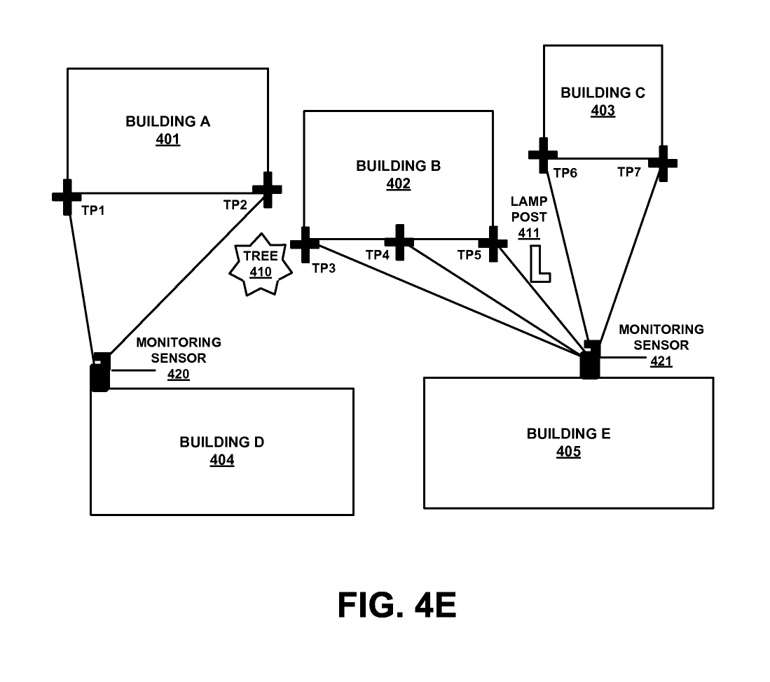

FIGS. 4A, 4B, 4C, 4D, and 4E are plan views of a street illustrating features of a real-time site monitoring design process in accordance with embodiments of the present technology. In FIG. 4A, a plurality of buildings A, B, and C (e.g., 401, 402, and 403 respectively) are to be monitored for a project. On building 401, two target points (TPs) are to be monitored (e.g., TP1 and TP2). On building 402, three target points are to be monitored, TP3, TP4, and TP5. On building 403, two target points are to be monitored, TP6 and TP7. In FIG. 4A, two potential obstructions exist (e.g., tree 410 and lamp post 411) which could prevent a monitoring sensor (e.g., monitoring sensor 420) from receiving monitoring data from various target points at the site. In FIG. 4A, real-time site monitoring design system 120 places monitoring sensor 420 at a first position, e.g. position X, at a corner of building 404 within the 3-D model. Real-time site monitoring design system 120 then performs an operation to determine the field of view between monitoring sensor 420 and various target points which are to be monitored. In FIG. 4A, real-time site monitoring design system 120 determines that the field of view of monitoring sensor to TP1 and TP2 is not obstructed when monitoring sensor 420 is located at position X. However, real-time site monitoring design system 120 also determines that the field of view between monitoring sensor 420 and TP3, as well as to TP4, is obstructed by tree 410. Also, real-time site monitoring design system 120 determines that the range from monitoring sensor 420 to TP5 exceeds detection range of monitoring sensor 420.

In FIG. 4B, real-time site monitoring design system 120 performs an operation in which the position of monitoring sensor 420 is moved from position X to a second position, position X+1. Real-time site monitoring design system 120 then performs an operation to determine the field of view from monitoring sensor 420 at position X+1 to various target points to be monitored. In FIG. 4B, real-time site monitoring design system 120 determines that the field of view to TP1 is not obstructed, but the field of view to TP2 is obstructed when monitoring sensor 420 is located at position X+1. Additionally, monitoring sensor 420 has a clear field of view of TP3, TP4, and TP5 when located at position X+1. In one embodiment, real-time site monitoring design system 120 then assigns position X+1 as the temporary optimum position for monitoring sensor 420.

In FIG. 4C, real-time site monitoring design system 120 places a second monitoring sensor 421 within the 3-D model at a first position, e.g. position Y, at a corner of building 405 within the 3-D model. Real-time site monitoring design system 120 then determines the field of view of monitoring sensor 421 to various target points when it is located at position Y. As shown in FIG. 4C, real-time site monitoring design system 120 determines that the field of view of monitoring sensor 421 to TP1 is obstructed by tree 410 and the field of view to TP2 is obstructed by building 402. However, monitoring sensor 421 has a clear field of view to TP3, TP4, TP5, and TP6. The field of view from monitoring sensor 421 to TP7 is obstructed by lamp post 411.

In FIG. 4D, real-time site monitoring design system 120 performs an operation in which the position of monitoring sensor 420 is moved from position Y to a second position, position Y+1. Real-time site monitoring design system 120 then performs an operation to determine the field of view from monitoring sensor 421 at position Y+1 to various target points to be monitored. As shown in FIG. 4D, real-time site monitoring design system 120 determines that the field of view from monitoring sensor 421 when located at position Y+1 is clear to TP3, TP4, TP5, TP6, and TP7. However, the field of view to TP2 is obstructed by building 420 and the range to TP1 exceeds the detection range of monitoring sensor 421. As above, real-time site monitoring design system 120 then assigns position Y+1 as a temporary optimum position for monitoring sensor 421.

In one embodiment, real-time site monitoring design system 120 then performs an operation to test the combinations of monitored target points when monitoring sensor 420 is located at position X+1 and monitoring sensor 421 is located at position Y+1. As discussed above, when monitoring sensor 420 is located at position X+1 and monitoring sensor 421 is located at position Y+1, neither monitoring sensor can monitor TP2. In one embodiment, as shown in FIG. 4E, real-time site monitoring design system 120 re-positions monitoring sensor 420 at position X and tests the combinations of monitored target points while monitoring sensor 421 is still located at position Y+1. As shown in FIG. 4A, monitoring sensor 420 has a clear field of view of TP1 and TP2 when located at position X. Additionally, monitoring sensor Y+1 has a clear field of view when located at position Y+1. Thus, the combination of locating monitoring sensor 420 at position X and placing monitoring sensor 421 at position Y+1 permits monitoring of all target points. In one embodiment, real-time site monitoring design system 120 will then assign position X as the optimum position for monitoring sensor 420 and position Y+1 as the optimum position for monitoring sensor 421. It is noted that the representation of the field of view of the monitoring sensors within the 3-D model can be represented as a sphere (e.g., range and field of view) when determining the optimum position for placing monitoring sensors. In one embodiment, if none of the above combinations of positions for monitoring sensors 420 and 421 provides adequate coverage of the site, real-time site monitoring design system 120 will add another monitoring sensor at a third location and begin the process until the specified level of coverage of target points at the site is achieved.

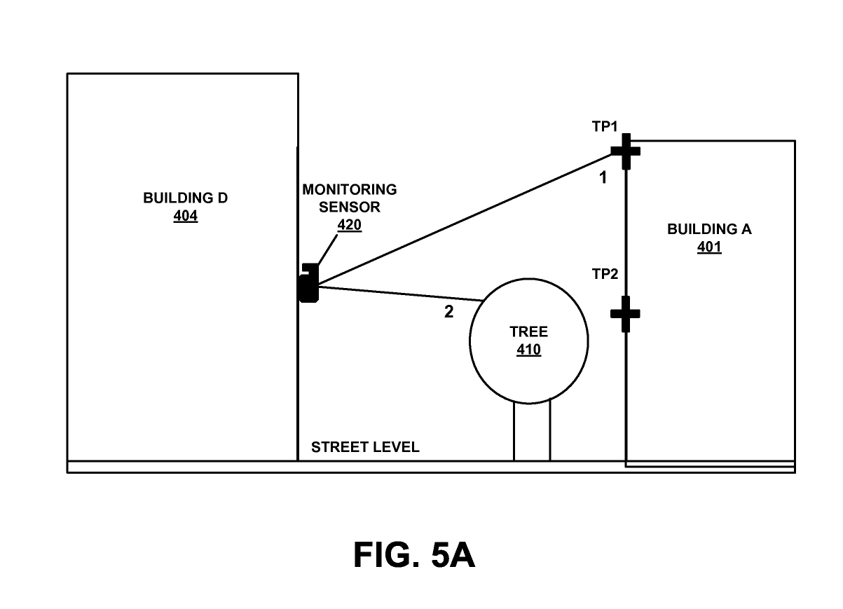

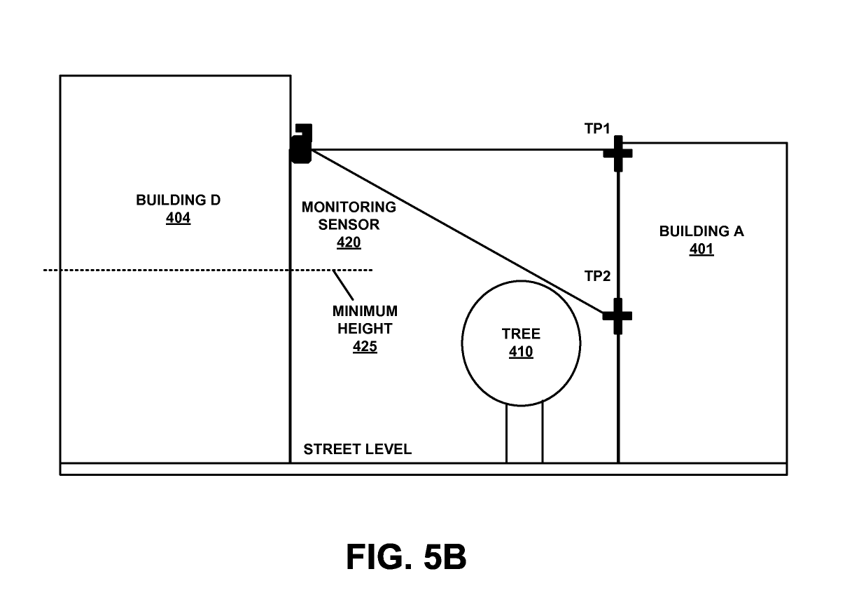

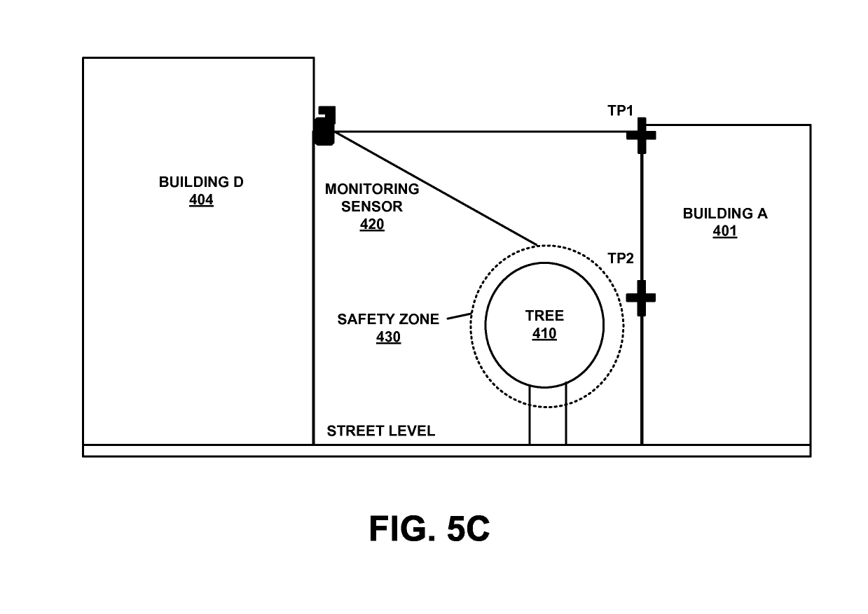

FIGS. 5A, 5B, and 5C are section views of a street illustrating features of a real-time site monitoring design process in accordance with embodiments of the present technology. In FIG. 5A, real-time site monitoring design system 120 determines that the field of view from monitoring sensor 420 to TP2 is obstructed by tree 410 when placed on the side of building 404. However, the field of view from monitoring sensor 420 to TP1 is not obstructed when placed on the side of building 404. In a manner similar to that described above with reference to FIGS. 4A-4E, real-time site monitoring design system 120 can re-position monitoring sensor 420 vertically as well as laterally in order to obtain a clear field of view to various target points.

Referring now to FIG. 5B, real-time site monitoring design system 120 has re-positioned monitoring sensor 420 up higher on building 404 to determine whether it has fewer obstructions in its field of view. As shown in FIG. 5B, when monitoring sensor 420 is moved up higher on building 404, it now has a clear field of view to TP2 as well as maintaining its clear field of view to TP1. In one embodiment, real-time site monitoring design system 120 would then assign the higher position on building 404 as a temporary optimum position for monitoring sensor 420.

In one embodiment, a minimum height can be designated which indicates where instruments cannot be placed by real-time site monitoring design system 120 within the 3-D model. For example, to prevent damage or theft of equipment (e.g., monitoring sensor 420, target prisms, etc.) a user can designate a minimum height below which no equipment can be placed. As a result, real-time site monitoring design system 120 will not place equipment below this minimum height in the 3-D model when determining the placement of site monitoring equipment. As shown in FIG. 5C, a user can also designate a safety zone (e.g., safety zone 430) around features within the site to be monitored. For example, some features (e.g., doors, equipment, shrubbery, etc.) may be able to move and thus be able to obstruct the field of view of monitoring sensors occasionally. In the example of FIG. 5C, tree 410 could be blown by the wind and potentially obstruct the field of view between monitoring sensor 420 and TP2. By assigning safety zone 430 around tree 410, a user of real-time site monitoring design system 120 is better able to place monitoring equipment at a site while reducing the possibility of occasional interruption of receiving monitoring data by monitoring sensor 420. As shown in FIG. 5C, real-time site monitoring design system 120 determines that the field of view between monitoring sensor 420 and TP2 is obstructed by the safety zone 430 which has been placed around tree 410.

Embodiments of the present technology are thus described. While the present technology has been described in particular embodiments, it should be appreciated that the present technology should not be construed as limited to these embodiments alone, but rather construed according to the following claims.

What is claimed is:

1. A method for designing a system for real-time site monitoring, said method comprising:
accessing a three-dimensional (3-D) model of a site by a computer system;
determining a location for placing a monitoring sensor at said site by said computer system; and
determining by said computer system whether there is an obstruction at said site which inhibits receiving monitoring data by said monitoring sensor when at said location.

2. The method of claim 1 further comprising:
receiving spatial data by said computer system; and
deriving said 3-D model by said computer system based upon said spatial data.

3. The method of claim 1 further comprising:
generating a message by said computer system indicating that said monitoring sensor is inhibited from receiving monitoring data.

4. The method of claim 3 further comprising:
generating by said computer system a second location where said monitoring sensor is not inhibited from receiving monitoring data.

5. The method of claim 3 wherein said monitoring sensor comprises a satellite navigation receiver, said method further comprising:
determining by said computer system that said satellite navigation receiver is inhibited from receiving satellite navigation data from a satellite; and
generating by said computer system a second location where said satellite navigation receiver is not inhibited from receiving navigation data from said satellite.

6. The method of claim 1 further comprising:
determining by said computer system that an area within said site is not monitored by said monitoring sensor; and
generating by said computer system a message indicating that said area is not being monitored.

7. The method of claim 1 further comprising:
generating by said computer system a list of equipment for implementing monitoring of said site using said monitoring sensor.

8. The method of claim 7 further comprising:
accessing by said computer system an inventory of equipment;
comparing by said computer system said list of equipment with said inventory;
determining by said computer system that an item on said list of equipment is not described in said inventory; and
generating by said computer system a message indicating that said item is not available.

9. The method of claim 8 further comprising:
automatically generating by said computer system an order to obtain said item.

10. The method of claim 1 further comprising:
generating by said computer system an estimate of the time needed to implement a real-time monitoring system at said site; and
generating by said computer system an estimate of cost for implementing said real-time monitoring system at said site.

11. The method of claim 1 further comprising:
generating by said computer system a file for causing said monitoring sensor to initiate a calibration sequence.

12. The method of claim 1 wherein said determining said location comprises:
automatically determining by said computer system said location for said placing said monitoring sensor.

13. A computer system comprising:
a bus;
a memory coupled with said bus; and
a processor coupled with said bus, wherein said processor is configured for:
accessing a three-dimensional (3-D) model of a site by a computer system;
determining a location for placing a monitoring sensor at said site by said computer system; and
determining by said computer system whether there is an obstruction at said site which inhibits receiving monitoring data by said monitoring sensor when at said location.

14. The computer system of claim 13 wherein said processor is further configured for:
receiving spatial data by said computer system; and
deriving said 3-D model by said computer system based upon said spatial data.

15. The computer system of claim 13 wherein said processor is further configured for:
generating a message by said computer system indicating that said monitoring sensor is inhibited from receiving monitoring data.

16. The computer system of claim 15 wherein said processor is further configured for:
generating by said computer system a second location where said monitoring sensor is not inhibited from receiving monitoring data.

17. The computer system of claim 15 wherein said monitoring sensor comprises a satellite navigation receiver and wherein said processor is further configured for:
determining by said computer system that said satellite navigation receiver is inhibited from receiving satellite navigation data from a satellite; and
generating by said computer system a second location where said satellite navigation receiver is not inhibited from receiving navigation data from said satellite.

18. The computer system of claim 13 wherein said processor is further configured for:
determining by said computer system that an area within said site is not monitored by said monitoring sensor; and
generating by said computer system a message indicating that said area is not being monitored.

19. The computer system of claim 13 wherein said processor is further configured for:
generating by said computer system a list of equipment for implementing monitoring of said site using said monitoring sensor.

20. The computer system of claim 19 wherein said processor is further configured for:
accessing by said computer system an inventory of equipment;
comparing by said computer system said list of equipment with said inventory;
determining by said computer system that an item on said list of equipment is not described in said inventory; and
generating by said computer system a message indicating that said item is not available.

21. The computer system of claim 20 wherein said processor is further configured for:
automatically generating by said computer system an order to obtain said item.

22. The computer system of claim 13 wherein said processor is further configured for:
generating by said computer system an estimate of time needed to implement a real-time monitoring system at said site; and
generating by said computer system an estimate of cost for implementing said real-time monitoring system at said site.

23. The computer system of claim 13 wherein said processor is further configured for:
generating by said computer system a file for causing said monitoring sensor to initiate a calibration sequence.

24. The computer system of claim 13 wherein said determining said location comprises:
automatically determining by said computer system said location for said placing said monitoring sensor.

25. A non-transitory computer-readable storage medium having computer-readable instructions embodied thereon which, when executed, cause a computer system to implement a method for designing a system for real-time site monitoring, said method comprising:
accessing a three-dimensional (3-D) model of a site by a computer system;
determining a location for placing a monitoring sensor at said site by said computer system; and
determining by said computer system whether there is an obstruction at said site which inhibits receiving monitoring data by said monitoring sensor when at said location.

26. The non-transitory computer-readable storage medium of claim 25 wherein said method further comprises:
receiving spatial data by said computer system; and
deriving said 3-D model by said computer system based upon said spatial data.

27. The non-transitory computer-readable storage medium of claim 25 wherein said method further comprises:
generating a message by said computer system indicating that said monitoring sensor is inhibited from receiving monitoring data.

28. The non-transitory computer-readable storage medium of claim 27 wherein said method further comprises:
generating by said computer system a second location where said monitoring sensor is not inhibited from receiving monitoring data.

29. The non-transitory computer-readable storage medium of claim 27 wherein said monitoring sensor comprises a satellite navigation receiver, and wherein said method further comprises:
determining by said computer system that said satellite navigation receiver is inhibited from receiving satellite navigation data from a satellite; and
generating by said computer system a second location where said satellite navigation receiver is not inhibited from receiving navigation data from said satellite.

30. The non-transitory computer-readable storage medium of claim 25 wherein said method further comprises:
determining by said computer system that an area within said site is not monitored by said monitoring sensor; and
generating by said computer system a message indicating that said area is not being monitored.

31. The non-transitory computer-readable storage medium of claim 25 wherein said method further comprises:
generating by said computer system a list of equipment for implementing monitoring of said site using said monitoring sensor.

32. The non-transitory computer-readable storage medium of claim 31 wherein said method further comprises:
accessing by said computer system an inventory of equipment;
comparing by said computer system said list of equipment with said inventory;
determining by said computer system that an item on said list of equipment is not described in said inventory; and
generating by said computer system a message indicating that said item is not available.

33. The non-transitory computer-readable storage medium of claim 32 wherein said method further comprises:
automatically generating by said computer system an order to obtain said item.

34. The non-transitory computer-readable storage medium of claim 25 wherein said method further comprises:
generating by said computer system an estimate of the time needed to implement a real-time monitoring system at said site; and
generating by said computer system an estimate of cost for implementing said real-time monitoring system at said site.

35. The non-transitory computer-readable storage medium of claim 25 wherein said method further comprises:
generating by said computer system a file for causing said monitoring sensor to initiate a calibration sequence.

36. The non-transitory computer-readable storage medium of claim 25 wherein said determining said location comprises:
automatically determining by said computer system said location for said placing said monitoring sensor.

37. The non-transitory computer-readable storage medium of claim 25 wherein said determining whether there is an obstruction at said site further comprises:
specifying a zone around a feature at said site in which receiving monitoring data by said monitoring sensor when at said location is occasionally interrupted.

38. The non-transitory computer-readable storage medium of claim 25 wherein said determining a location for placing a monitoring sensor at said site by said computer system further comprises:
placing said monitoring sensor above a specified minimum height within said 3-D model of said site.
